(19) United States
(12) Patent Application Publication
(10) Pub. No.: US 2024/0393195 A1
(43) Pub. Date: Nov. 28, 2024

(54) ELECTRICAL COMPONENT

(71) Applicants: Fraunhofer-Gesellschaft zur Förderung der angewandten Forschung e.V., München (DE); NOWOFOL Kunststoffprodukte GmbH & Co. KG, Siegsdorf (DE); adidas AG, Herzogenaurach (DE)

(72) Inventors: Oliver HAALA, Erlangen (DE); Peter SPIES, Erlangen (DE); Henrik ZESSIN, Erlangen (DE); Torvinen VESA-PEKKA, Siivikkala (FI); Sabine HARTL, Grabenstätt (DE); Konstantin LUFT, Vachendorf (DE); Ulrich VON GROßMANN, Siegsdorf (DE); Ulf JENSEN, Bamberg (DE); Burkhard DÜMLER, Heroldsberg (DE)

(21) Appl. No.: 18/796,833

(22) Filed: Aug. 7, 2024

Related U.S. Application Data
(63) Continuation of application No. PCT/EP2022/053029, filed on Feb. 8, 2022.

(51) Int. Cl. G01L 1/16

(52) U.S. Cl. CPC G01L 1/162

(57) ABSTRACT

An electrical component having: a sensor cell; the sensor cell being configured to, firstly, detect a physical quantity and output an electrical measurement signal having at least three differentiable states based on the detected physical quantity and to, secondly, provide electrical energy when the physical quantity is applied.

### CROSS-REFERENCE TO RELATED APPLICATION

This application is a continuation of copending International Application No. PCT/EP2022/053029, filed Feb. 8, 2022, which is incorporated herein by reference in its entirety.

### TECHNICAL FIELD

Embodiments of the present invention relate to an electrical component, in particular an electrical component having a sensor cell. Further embodiments relate to corresponding applications, such as running shoes, mechanical systems, a floor covering, tires or tire components, such as a valve, sports equipment, e.g. a ball or racket, a prosthesis, an implant, a seat, a tube, a pipe, a tarp, a sail and/or a switch.

### BACKGROUND OF THE INVENTION

Sensors for detecting physical quantities, such as a force, vibration or pressure, typically use electrical energy to amplify the measurement signals and transmit the measurement data, e.g. externally. This requires batteries, for example, which provide the necessary energy to supply the sensor signal amplifier and the radio transceiver. However, these batteries have to be replaced and recharged regularly. This increases the maintenance effort and thereby causes costs. Particularly in the case of inaccessible installation locations, encapsulated systems and implants, this causes further problems and even makes certain applications impossible.

Other problems with the batteries used so far, which have to be recharged and replaced regularly, are that direct access to the sensor has always been necessary and the housing had to be opened and closed.

An alternative to this variation is the use of energy harvester technologies which use ambient energy, such as light and temperature differences or mechanical energy, to generate electrical energy at the location of the sensor. This allows the battery to be recharged during operation, thus eliminating the batteries being replaced.

The object underlying the present invention is to improve the concept of sensors, in particular wireless sensors or individual sensors.

### SUMMARY

According to an embodiment, a piece of clothing, running shoe, floor covering, seat, seating furniture, sports equipment, ball or prosthesis having an electrical component may have: a sensor cell; wherein the sensor cell is configured to, firstly, detect a physical quantity and output an electrical measurement signal according to at least one of three differentiable states based on the detected physical quantity and to, secondly, provide electrical energy when the physical quantity is applied; and an energy supply coupled to the sensor cell to receive the provided electrical energy.

Embodiments of the present invention provide an electrical component having a sensor cell. The sensor cell is configured to, firstly, detect a physical quantity, such as a force or pressure, and output an electrical measurement signal, e.g. an analog voltage, having at least three differentiable or differentiated states based on the detected physical quantity and to, secondly, provide or harvest electrical energy when the physical quantity is applied.

Embodiments of the present invention are based on the finding that a sensor cell can be provided with a double function, i.e. to detect a measurement variable (continuously or at least over several states) and to use the same physical quantity to harvest energy. The background to this is that energy converters, which can often be used alone in energy harvesting systems, can also be used as sensors or even actuators. This means that an energy harvester no longer has to be provided separately from the sensors on the common electronics board (on which a radio transmitter or another component can also be arranged, for example). This allows the electrical component (or sensor component) to be set up with considerably more degrees of freedom in that both the sensor and the energy harvester can be optimally positioned in one place in the sensor housing so that the latter can now be arranged directly at the location of the physical quantity of interest. All in all, this improves the detection of the physical measurement variable and energy harvesting and also saves installation space and, consequently, costs.

According to an embodiment, the voltage of a solar cell can be used both as a measure for illumination in a room and as a voltage for extracting electrical energy.

According to embodiments, a piezoelectric material can be used both for energy conversion and for mechanical sensing. Here, the piezoelectric material is used as an energy converter, for example, which provides electrical power in the form of an electrical voltage based on the mechanical deformation of the material itself or of a housing part. However, this electrical voltage at the same time is a measure of the mechanical force applied. For example, the deformation of a housing part may also be an indication of mechanical stress, which is to be counteracted if certain maximum values are exceeded. For this purpose, the piezo material/sensor element or the associated housing part can be integrated into the corresponding application, such as a shoe or piece of clothing or floor covering.

Embodiments of the present invention thus suggest using an energy converter the output signal of which can at the same time be used as information on a physical quantity, such as an existing deformation or mechanical stress. According to embodiments, three cases can be distinguished:
a) One and the same piece of material is additionally used as an energy converter and sensor. This means that, according to embodiments, the sensor cell is configured to detect the physical quantity and simultaneously provide electrical energy based on the physical quantity. For example, the output voltage, which charges the electrical power, for example in a capacitor, is monitored at the same time in order to obtain the relevant information (regarding the predominant mechanical force/tension/vibration) from this.
b) One and the same piece of material is used alternatingly either as an energy converter or as a sensor. Thus, according to further embodiments, the sensor cell is configured to detect the physical quantity, i.e. independently or subsequently to providing the electrical energy.
c) Two separate pieces of the same material are used, one as a sensor and the other as an energy converter. It would be conceivable, for example, for a sensor material to be segmented into different regions, one being used for sensing and the other for energy harvesting. According to embodiments, the sensor cell thus has at least two units (regions) or even two identical units (regions). In this variation, it is also possible for different regions of the same material to be used differently. In this case, the energy converter region and the sensor region may also be wired separately. According to embodiments, the first of the at least two (identical) regions can be configured to detect the physical quantity, wherein the other of the at least two (identical) regions is configured to provide the electrical energy.

According to further embodiments, the physical quantity can be a force, such as a tensile force, compressive force or transverse force, but also an acceleration or vibration. Other physical quantities, such as a light energy or temperature, are possible according to further embodiments.

According to further embodiments, the electrical component has an energy supply coupled to the sensor cell in order to receive the energy provided and process it correspondingly (rectify, smooth, store, etc.). According to embodiments, the current supply may have a capacitor, a battery or another (electrical) energy storage (for storing electrical energy).

According to further embodiments, the electrical component has measurement electronics connected to the sensor cell and configured to receive the electrical signal having the at least three states to be differentiated, to process it further, such as digitizing it (with at least three corresponding states) and transmit it externally or externally by radio. This means that, in addition to the measurement electronics, a transceiver may also be provided in the electronic component. In addition, a further consumer (e.g. actuator, display, . . .) can be connected to the electrical component, performing corresponding actions (e.g. alarm, change in properties, opening a valve, . . .) based on the measurement values.

According to further embodiments, the electrical component has a housing in which the sensor cell is integrated or embedded. The sensor cell may be coupled to the housing, for example, in order to obtain a deformation of the housing and thus the physical quantity acting on the housing.

Embodiments of the present invention provide a corresponding application, for example an application among the following:
running shoe,
mechanical system,
floor covering,
tire or tire component, such as a valve,
sports equipment, such as a ball or racket,
prosthesis or implant,
seat or seating furniture,
tube or pipe,
sail or tarp,
rope or cable,
switch,
   wherein the corresponding application comprises the electrical component as explained above.

### BRIEF DESCRIPTION OF THE DRAWINGS

Embodiments of the present invention are explained below referring to the appended drawings, in which:

FIG. 1a is a schematic representation of an electrical component according to a basic design example;

FIG. 1b is a schematic representation of an electrical component according to a further embodiment; and

FIG. 2 is a schematic representation of a shoe having an integrated electrical component according to further embodiments.

### DETAILED DESCRIPTION OF THE INVENTION

Before explaining embodiments of the present invention referring to the appended drawings, it is to be noted that elements and structures of equal effect are provided with equal reference numerals so that the description thereof is mutually applicable or interchangeable.

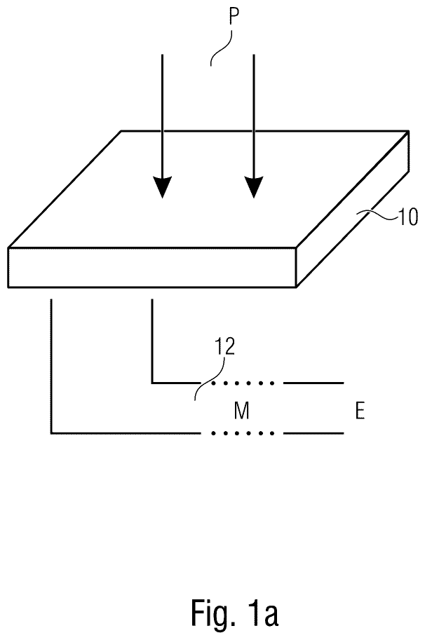

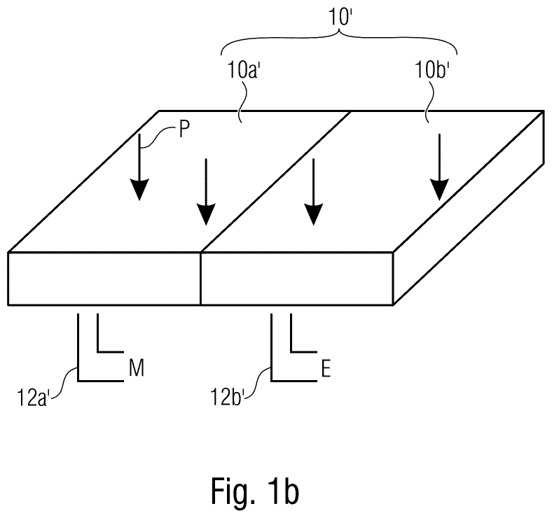

FIG. 1 shows a sensor cell 10 of an electrical component. The sensor cell 10 has an electrical output, such as a voltage tap or a measurement signal output 12. When a physical quantity P acts on the sensor cell 10, both the signal M and the signal E are output at the sensor output 12. The signal M represents a measurement signal, while the signal E is an energy signal. Both signals may be identical.

The sensor cell 10 is a piezo element, for example. When a mechanical force P is applied, an electrical voltage is induced at the output 12. This electrical voltage is dependent on, e.g. proportional to the acting force P, so that this electrical voltage can be used as the measurement signal M. At the same time, the electrical voltage at the output 12 causes a current flow so that electrical energy E can be extracted from this voltage signal. This allows harvesting electrical energy E, e.g. by force/forces acting on the sensor cell anyway, based on vibrations or actuation. According to embodiments, this electrical energy E can be used directly or buffered. Buffering advantageously allows adding up several smaller amounts of energy E over time so that a sufficient amount of energy is available for short-term demand. The physical quantity can also be determined simultaneously or independently of the harvested energy. For this purpose, the sensor cell 10 outputs the measurement signal M, e.g. a measurement voltage. This measurement voltage is dependent on, e.g. proportional or directly proportional to, the acting force P. According to embodiments, the measurement signal M is such that at least three states can be differentiated (e.g. 0 volts with no external load, such as 0 newtons/0.2 volts with a light external load, e.g. 0.2 newtons/0.4 volts with a high external load, e.g. 0.8 newtons). According to embodiments, the measurement signal M may also be a continuous measurement signal and/or have a plurality/multitude of states. According to further embodiments, the measurement signal may also be a negative measurement signal, e.g. if the physical measured variable P<0, i.e. acting in the opposite direction (opposite to the direction of the arrow shown). According to further embodiments, the measured variable P does not necessarily have to be a tensile force, a vibration or a pressure/compressive force or a shear force or even a velocity or movement, e.g. in the form of a rotation, would also be conceivable.

Referring to FIG. 1b, a further variation is explained. FIG. 1b shows a sensor cell 10′ having two regions 10a′ and 10b′. The two regions 10a′ and 10b′ may, for example, be identical and together form the sensor cell 10′. In this embodiment, for example, it is assumed that both are piezo elements which, based on an externally acting physical measurement variable P, maintain a corresponding voltage at the respective output 12a′ and 12b′. The region 10a′ is responsible for establishing the measurement variable P and outputs its measurement signal M at the output 12a′.

The region 10b′ is used for harvesting energy and emits an energy signal at the output 12b′.

According to embodiments, these regions 10a′ and 10b′ may be identical in terms of their electrical property, but also identical in terms of their size. According to further embodiments, the sizes may also differ. For example, it is conceivable for the region 10b′ to take up more space so that a sufficient amount of energy can be harvested.

According to embodiments, the sensor cell 10′, i.e. with the regions 10a′ and 10b′, may be realized by a large-area, segmented energy converter, such as PVDF films. These enable sensor monitoring of larger regions without using dedicated sensors.

The use of an energy converter as a sensory element makes the setup of self-sufficient sensor systems easier. Additional sensors, often connected externally by cable, are no longer necessary. This allows reducing installation space and costs. Furthermore, the reduction in the number of components results in a lower probability of failure. According to embodiments, the sensor cell 10 or 10′ may be expanded to include additional components, such as energy rendering at the output 12 or 12b′ or measurement electronics at the output 12 or 12a′. Energy rendering (not shown) is configured to render the energy, e.g. to smooth, rectify and/or store the voltage. For this purpose, the energy rendering device may have a capacitor, generally a buffer capacity, a chargeable battery or a similar energy storage device. The measurement electronics may have an analog-to-digital converter which converts the measurement signal M into a digital measurement signal having at least three differentiable states and then transmits it externally, for example. According to embodiments, the transmission to the outside may take place by means of an additional radio module. According to embodiments, the radio module and the measurement electronics are operated by the energy E or the energy rendered by the energy supply. The advantage of energy buffering is that energy can be stored and buffered over a long period of time in order to perform the measurement and transmit the measured values at the corresponding points in time.

The simultaneous use of a material as an energy converter and sensor and possibly also as an actuator allows the sensor or actuator to be mounted or arranged directly at the location of the relevant measurement variable or controlled variable of interest. This will be explained below using a specific application, namely a running shoe.

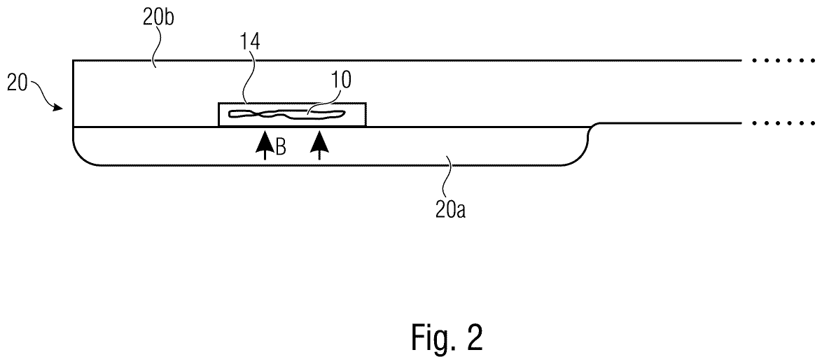

FIG. 2 shows a shoe sole 20 having a midsole 20b and an outsole 20a. The measurement element 10 is embedded in this sole 20 using a housing 14. The housing is configured such that the force P (or physical measurement variable P) acting on the housing is transmitted to the sensor cell 10. By embedding the sensor cell 10 together with the housing 14 in the shoe sole 20, it is possible for the component 10 to generate electrical energy so that the sensor unit 10 can be operated, and the physical quantity P to be measured can be measured at the same time. In running shoes, for example, the piezoelectric film can be used to detect kinetic and kinematic measurement variables (ground reaction force, foot strike angle, pronation behavior, running intensity, stride frequency, running symmetry, etc.) as well as to supply energy to the sensor system in the running shoe.

Especially in flexible applications, such as shoes, clothing or stickers, rigid sensors make the setup more difficult. In this embodiment, the housing may be formed by a film, for example. According to further embodiments, this film also carries the other components, such as the measurement electronics or the radio transceiver.

According to further embodiments, the sensor element may also have an actuator function or drive a separate actuator. Piezo elements, for example, enable the excitation of a movement when driving with an electrical signal and can thus assume the function of an actuator. Connected screens (e.g. LED) enable the direct display of the detected measurement variable or an alarm. Other mechanical systems can be used to change the properties of the device in which they are integrated, e.g. heating, mechanically amplifying or triggering dedicated actions, e.g. opening a valve, closing a circuit. The actuator is configured to exert a force when driven, e.g. as acoustic or haptic feedback.

Further applications are explained below.

An embodiment provides a mechanical system, such as a pump, a bearing, a clutch or a motor. Here, piezoelectric films can be used to detect the vibration as well as to supply the sensor system and, if applicable, for wireless data transmission. Vibrations and deformation are always a measure of mechanical stability (condition monitoring).

Another embodiment relates to a floor covering having a corresponding sensor cell. Piezoelectric transducers can be used here to detect people (e.g. presence detection). At the same time, the piezoelectric transducer can harvest the energy used for signal amplification and for data transmission itself.

According to a further embodiment, the sensor element can be integrated into a tire. Here, the tire pressure can be derived, for example. One possible integration is in the tire valve, for example.

According to another embodiment, the sensor cell can be integrated into sports equipment, such as a ball for ball sports or a racket. In this case, the sensor signal is used as feedback for the test subject about the condition of the equipment or the quality of the movement.

Another application is a prosthesis or an implant. In this respect, according to embodiments, the sensor cell can be integrated into a prosthesis, for example to enable walk analysis.

Another embodiment relates to a seat or seating furniture. The sensor cell can be used to monitor the seat position, seat duration, seat occupancy (airplane, cinema, bus, car, etc.).

Another embodiment relates to a switch. The flexible switch may output a switching signal by means of a radio signal, for example.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. A piece of clothing, running shoe, floor covering, seat, seating furniture, sports equipment, ball or prosthesis comprising an electrical component, comprising:
a sensor cell;
wherein the sensor cell is configured to, firstly, detect a physical quantity and output an electrical measurement signal according to at least one of three differentiable states based on the detected physical quantity and to, secondly, provide electrical energy when the physical quantity is applied;
an energy supply coupled to the sensor cell to receive the provided electrical energy.

2. The piece of clothing, running shoe, floor covering, seat, seating furniture, sports equipment, ball or prosthesis according to claim 1, wherein the sensor cell is configured to detect the physical quantity and at the same time provide electrical energy based on the physical quantity.

3. The piece of clothing, running shoe, floor covering, seat, seating furniture, sports equipment, ball or prosthesis according to claim 1, wherein the sensor cell is configured to detect the physical quantity, independently or subsequently to providing the electrical energy.

4. The piece of clothing, running shoe, floor covering, seat, seating furniture, sports equipment, ball or prosthesis according to claim 1, wherein the energy supply is configured to render the provided energy or to rectify or smooth or store a voltage of the provided energy.

5. The piece of clothing, running shoe, floor covering, seat, seating furniture, sports equipment, ball or prosthesis according to claim 4, wherein the energy supply comprises a capacitor, a battery or another type of energy storage.

6. The piece of clothing, running shoe, floor covering, seat, seating furniture, sports equipment, ball or prosthesis according to claim 1, wherein the electrical component comprises measuring electronics connected to the sensor cell and configured to receive, further process, and/or receive and digitize and/or receive and transmit externally or externally by radio the electrical signal according to the at least three differentiable states.

7. The piece of clothing, running shoe, floor covering, seat, seating furniture, sports equipment, ball or prosthesis according to claim 1, wherein the physical quantity comprises a force, tensile force, compressive force, transverse force, acceleration, rotation, pressure, velocity and/or vibration.

8. The piece of clothing, running shoe, floor covering, seat, seating furniture, sports equipment, ball or prosthesis according to claim 1, wherein the sensor cell comprises at least two or two identical regions.

9. The piece of clothing, running shoe, floor covering, seat, seating furniture, sports equipment, ball or prosthesis according to claim 8, wherein the first of the at least two or at least two identical regions is configured to detect the physical quantity, wherein the other of the at least two or at least two identical regions is configured to provide the electrical energy.

10. The piece of clothing, running shoe, floor covering, seat, seating furniture, sports equipment, ball or prosthesis according to claim 1, wherein the electrical component additionally comprises a housing into which the sensor cell is integrated and/or embedded.

11. The piece of clothing, running shoe, floor covering, seat, seating furniture, sports equipment, ball or prosthesis according to claim 1, wherein the sensor cell comprises a large-area energy converter, large-area segmented energy converter, segmented energy converter, a piezoelectric element and/or a PVDF film.

12. The piece of clothing, running shoe, floor covering, seat, seating furniture, sports equipment, ball or prosthesis according to claim 1, wherein the electrical component comprises an actuator or the sensor cell comprises an actuator, the actuator being configured to exert a force when driven.

13. The piece of clothing, running shoe, floor covering, seat, seating furniture, sports equipment, ball or prosthesis according to claim 1, wherein the sensor cell comprises a piezo film or flexible film; and/or
wherein the sensor cell comprises a thermoelectric generator and/or solar cell, in particular a flexible solar cell.
